(19) United States
(12) Patent Application Publication
(10) Pub. No.: US 2026/0037913 A1
(43) Pub. Date: Feb. 5, 2026

(54) LLM-ASSISTED NETWORK ANALYSIS AND OPTIMIZATION FOR ROBUST SUPPLY CHAINS

(71) Applicant: Honda Motor Co., Ltd., Tokyo (JP)

(72) Inventors: Sebastian Brulin, Offenbach (DE); Stefan Menzel, Offenbach (DE)

(73) Assignee: Honda Motor Co., Ltd., Tokyo (JP)

(21) Appl. No.: 18/788,162

(22) Filed: Jul. 30, 2024

(51) Int. Cl. G06Q 10/0835; G06Q 10/0635

(52) U.S. Cl. CPC G06Q 10/08355; G06Q 10/0635

(57) ABSTRACT

A method and a system for analyzing a transportation network in a logistic supply chain, the method including acquiring unstructured information from plural information sources and information on the transportation network. Analyzing the unstructured information utilizing a large language model for generating structured information. Analyzing historical information in the structured information and identifies correlations between events and disruptions in the transportation network for determining risks metrics. Generating a dynamic graph comprising nodes and edges, and determining critical transportation routes and critical links of the transportation network by performing a spectral analysis of the dynamic graph utilizing the determined risk metrics. Minimizing a risk of the transportation network by adjusting transportation routes based on the critical transportation routes and the critical links and based on the risk metrics until a termination criterion is met. Generating and outputting an analysis signal including information on the adjusted transportation routes of the transportation network.

### BACKGROUND OF THE DISCLOSURE

### Technical Field of the Disclosure

The disclosure relates to the general field of supply chain management, and further concerns techniques from the fields of natural language processing (NLP), in particular large language models (LLM), and spectral graph analysis from network theory.

### Technical Background

Supply chain management systems use periodically updated information or even static information, in order to devise and adapt the supply chains of enterprises, which currently span over large areas of the globe. In consequence, the supply chains lack the capability to adapt swiftly and reliably to sudden environmental changes affecting the supply chains, e.g. affecting a transportation network used for transporting physical objects such as materials and goods in the supply chain.

Examples for environmental changes affecting the supply chain include natural disasters comprising, e.g., certain weather events, volcanic events, or man-caused disruptions that may include, e.g., industrial strikes, transport strikes, traffic events, or cultural events.

Conventional supply chain management systems and their inefficiency in coping with rapidly changing situations hence suffer from suboptimal routing along the transportation network(s) used in the supply chain, increases in transportation cost, delays in delivery schedules, and generally a high susceptibility to disruptions in the transportation network(s).

A target of the disclosure is to improve robustness of logistic supply chains, and, in particular, to optimize logistic networks by adjusting transportation routes used in the logistic supply chains.

### SUMMARY

The method for analyzing a transportation network in a logistic supply chain in a first aspect, the corresponding computer program in a second aspect, and the system for analyzing a transportation network in a logistic supply chain in a third aspect achieve these targets in an advantageous manner.

The computer-implemented method for analyzing a transportation network in a logistic supply chain of the first aspect includes steps of acquiring unstructured information from plural information sources and information on the transportation network. The method then proceeds with analyzing the unstructured information utilizing a large language model for generating structured information. The method analyzes historical information in the structured information and identifies correlations between events and disruptions in the transportation network for determining risks metrics. The method generates a dynamic graph comprising nodes and edges, wherein time-dependent weights associated with the edges represent transportation rates along the edges, and determining critical transportation routes and critical links of the transportation network by performing a spectral analysis of the generated dynamic graph utilizing the determined risk metrics. The method minimizes a risk of the transportation network by adjusting transportation routes based on the critical transportation routes and the critical links, and based on the risk metrics until a termination criterion is met. When the termination criterion has been met, the method generates and outputs an analysis signal including information on the adjusted transportation routes of the transportation network.

The transportation network may include a road traffic network. Alternatively, the transportation network combines a plurality of different transportation networks including but not limited to ground traffic networks involving a plurality of different transportation means, ship transportation networks via sea, sea-lanes, natural waterways, e.g. rivers and lakes, artificial waterways, e.g. channels, and air transportation networks including airfreight.

Transportation means for ground traffic networks may include transport of physical objects and material using train, lorry, car, motorcycle, bicycle, cart, or carrying by humans, for citing some examples.

A non-transitory computer-readable storage medium in a second aspect embodies a program of machine-readable instructions executable by a digital processing apparatus, which cause the digital processing apparatus to perform operations according to the method of the first aspect.

A system for analyzing a transportation network in a logistic supply chain in a third aspect comprises a processor, a data storage, a network interface and an output interface. The processor is configured to acquire, via the network interface, unstructured information from plural information sources and information on the transportation network. The processor is further configured to analyze the unstructured information utilizing a large language model for generating structured information, to analyze historical information in the structured information and identifying correlations between events and disruptions in the transportation network for determining risks metrics, and to generate a dynamic graph comprising nodes and edges. Time-dependent weights associated with the edges represent transportation rates along the edges. The processor is further configured to determine critical transportation routes and critical links of the transportation network by performing a spectral analysis of the dynamic graph utilizing the determined risk metrics, to minimize a risk of the transportation network by adjusting transportation routes based on the critical transportation routes and the critical links and based on the risk metrics until a termination criterion is met. The processor is further configured to generate and output, via an output interface, an analysis signal including information on the adjusted transportation routes of the transportation network when the termination criterion has been met.

### BRIEF DESCRIPTION OF THE DRAWINGS

The aspects and implementation of the present disclosure will be explained in the following description of specific embodiments in relation to the enclosed drawings, in which:

FIG. 1 shows a flowchart providing an overview over a method for analyzing a transportation network in a logistic supply chain;

FIG. 2 shows a block diagram illustrating an overview over a system for analyzing a transportation network in a logistic supply chain;

FIG. 3 shows a block diagram illustrating preprocessing and semantic analysis in the system for analyzing a transportation network in a logistic supply chain;

FIG. 4 shows a block diagram illustrating pattern recognition and forecasting in the system for analyzing a transportation network in a logistic supply chain;

FIG. 5 shows a block diagram illustrating generating and analyzing a dynamic graph representation in the system for analyzing a transportation network in a logistic supply chain;

FIG. 6 shows a block diagram illustrating the analysis of a dynamic graph representation of the transportation network in the system for analyzing a transportation network in a logistic supply chain;

FIG. 7 shows a block diagram illustrating the LLM-enhanced supply chain reconfiguration in the system for analyzing a transportation network in a logistic supply chain; and

FIG. 8 provides a processing hardware example of the system for analyzing a transportation network in a logistic supply chain.

The detailed description of the accompanying figures uses same references numerals for indicating same, similar, or corresponding elements in different instances. The description of figures dispenses with a detailed discussion of same reference numerals in different figures whenever considered possible without adversely affecting comprehensibility. The drawings are not necessarily to scale. Generally, operations of the disclosed processes may be performed in an arbitrary order unless otherwise provided in the claims.

### DETAILED DESCRIPTION

The method of the first aspect and the system of the third aspect for optimizing a transportation network in a logistic supply chain are advantageous due to overcoming the limitations of known approaches in supply chain management by integrating and analyzing unstructured data, in particular even real-time unstructured data to optimize logistical network performance in the dynamic environment.

Compared to previously known approaches, the method according to the first aspect overcomes a reliance on structured data sources, combining the accessibility of unstructured data sources for information gathering with spectral network analysis to efficiently identify and utilize the most robust transportation routes within the transportation network. The method defines techniques for a data-driven decision-making in real-time, to improve efficiency, resilience, and adaptability in supply chain management.

Conventional approaches in supply chain management usually fail to leverage the vast amounts of unstructured and non-textual data available from different sources such as news portals, social media, news outlets, and internet-of-things (IoT) devices. Contrary thereto, the method according to the first aspect benefits from the valuable insights into real-time conditions affecting the supply chain available from these different sources.

The method according to the first aspect defines a process that enhances the adaptability, efficiency, and resilience of logistic supply chains and their transportation networks by integrating spectral graph analysis with the advanced data processing capabilities of LLMs. At the core of the method, the process involves acquiring and processing real-time, unstructured data to provide updated inputs in time for the logistic supply chain. The process also involves employing spectral graph analysis to identify dynamically critical transportation routes and to adjust the weights of transportation links based on the real-time input, and continuously optimizing the transportation network in response to the evolving environmental conditions.

The method according to the first aspect defines a methodology that significantly improves performance of the logistic supply chain by enhancing the robustness of the network, thereby improving overall delivery efficiency, a critical measure of success for any logistical operation.

The method provides a dynamic adaptability to reduce delays in deliveries of items and enables forecasting delivery time currently not available in this extent and with such reliability. The precision in predicting delivery schedules provides tangible benefits, notably in the form of cost savings not only in transportation but also in manufacturing, distribution, and retail. Dynamic optimization of the transportation network minimizes detours and inefficiencies, directly affects transportation cost by ensuring that the most efficient transportation routes are known and selected in a highly dynamic environment.

The dependent claims define further advantageous embodiments.

According to an embodiment, the computer-implemented method for analyzing a transportation network comprises determining the risk metrics including estimating a first risk metric and a second risk metric associated with each risk. The first risk metric represents an expected disruption impact of the risk and the second risk metric a probability of the occurrence of the risk.

In an embodiment of the computer-implemented method for analyzing a transportation network, determining the risk metrics includes representing the structured information in a graph in a sequence of events, detecting motifs in the graph that correspond to recurring subgraphs in the graph that are determined by applying an advanced pattern recognition algorithm on the graph, and estimating the risk metrics based on the detected motifs in the graph.

The advanced pattern algorithm may comprise, e.g., frequent subgraph mining, graph-based substructure pattern mining, in particular gSpan.

The computer-implemented method for analyzing a transportation network according to an embodiment comprises generating the dynamic graph including modelling the transportation network based on the information on the transportation network with edges between nodes representing transportation links with the time-dependent weights and storing the dynamic graph in a dynamic graph database.

According to an embodiment of the computer-implemented method for analyzing a transportation network, the acquired unstructured information includes current unstructured information. The method includes updating the risk metrics based on current structured information generated by analyzing the unstructured current information using the large language model; determining the critical transportation routes and the critical links of the transportation network by performing the spectral analysis of the dynamic graph utilizing the updated risk metrics; and minimizing the risk of the transportation network by adjusting the transportation routes based on the critical transportation routes and the critical links and based on the updated risk metrics until a termination criterion is met.

Current unstructured information may in particular be unstructured information that is acquired in real-time or almost real-time (near real-time). Information in real-time may include a time delay introduced due to data processing or network transmission smaller than 1 minute, while near real-time refers to time delays between 1 and 10 minutes, for example.

The computer-implemented method for analyzing a transportation network according to an embodiment acquires the unstructured information from the plural information sources that include at least one of media platforms, news providers, podcast distributing platform, news agencies.

According to an embodiment of the computer-implemented method for analyzing a transportation network, the structured information comprises the historical information including risk information on past events from a risk event database.

The computer-implemented method for analyzing a transportation network according to an embodiment comprises acquiring logistic supply chain data including information of the transportation network.

According to an embodiment of the computer-implemented method for analyzing a transportation network, the acquired unstructured information includes current unstructured information; and the method comprises a step of updating predictive risk models stored in the risk event database based on a difference of current unstructured information and previously acquired unstructured information relevant for the critical transportation routes.

The computer-implemented method for analyzing a transportation network according to an embodiment comprises, for each time step, acquiring real-time information including current unstructured information; analyzing the current unstructured information utilizing the large language model for generating current structured information; and updating the risk metrics for each risk stored in the risk event database based on the current structured information. The method further comprises updating the time-dependent weights of the dynamic graph stored in the dynamic graph database based on the current structured information and the risk metrics stored in the risk event database for determining variations that affect departure and arrival times of transported items between nodes along the respective edge and storing the updated time-dependent weights for an updated dynamic graph in the dynamic graph database; determining initial transportation routes of the transportation network by performing the spectral analysis of the updated dynamic graph utilizing the updated risk metrics and storing the initial transport routes as transport routes in a route database; and determining a main transport route and critical transportation links based on minimizing the updated risk metrics of the transportation routes stored in the route database. The method minimizes the risk of the transportation network by adjusting the transportation routes based on the main transportation route and the critical transportation links and based on the updated risk metrics until the termination criterion is met. The method generates and outputs the analysis signal including information on the adjusted transportation routes of the transportation network when the termination criterion has been met.

According to an embodiment of the computer-implemented method for analyzing a transportation network minimizing the risk of the transportation network comprises, for each time step, determining areas of the dynamic graph that are vulnerable to disruptions for assessing a criticality of the transportation routes and an overall network robustness of the transportation network. The method outputs the determined areas of the dynamic graph in the analysis signal.

In the computer-implemented method for analyzing a transportation network according to an embodiment minimizing the risk of the transportation network comprises, for each time step, adjusting iteratively the time-dependent weights and transportation routes based on updated risk models stored in the risk event database, and determining an overall risk measure of the transportation network, until the overall risk measure is below a risk threshold. In case the determined overall risk measure is below the risk threshold, the method stores the adjusted transportation routes in the transportation route database.

According to an embodiment, the computer-implemented method for analyzing a transportation network comprises analyzing an adjusted network graph including the adjusted transportation links utilizing the large language model for generating strategies for adapting the transportation network; generating optimized network adaptation recommendations based on the generated strategies; and outputting the optimized network adaptation recommendations via a user interface.

The optimized network adaptation recommendations comprise at least one of optimized transportation routes, adjusted transportation schedules and reallocated transportation resources.

Outputting the optimized transportation network recommendations may include highlighting reconfigured supply chain outputs in a visual output representing the adjusted dynamic graph.

Outputting the optimized network adaptation recommendations has the effect of mitigating risks and capitalizing on emergent opportunities for a fully autonomous action executed based on the output optimized network adaptation recommendations.

The computer-implemented method for analyzing a transportation network according to an embodiment comprises obtaining, via a user interface, a user input including questions on aspects of the transportation network; and analyzing an adjusted network graph including the adjusted transportation links utilizing the large language model for generating a response to the user input based on the acquired user input and the adjusted network graph stored in the network graph database. The method further includes outputting the generated response to the user via the user interface.

The user input including questions on aspects of the transportation network may include, e.g., risk levels associated with transportation routes, alternative transportation routes, or potential bottlenecks in the transportation network.

The user input may be obtained in an audible format, e.g. acquired via microphone. The user input in an audible format may be converted into a natural language file and processing the user input may therefore use natural language processing.

Hence, the method provides an LLM-enhanced user interface that enables the method to understand and respond to operator queries, thereby providing tailored insights into the transportation network that are accurate in time.

According to an embodiment of the computer-implemented method for analyzing a transportation network, the user input includes information on real-time events or information on constraints for the transportation network; and the method comprises analyzing the user input for generating structured user input information in the structured information utilizing the large language model.

Information on real-time events may include information of road closures, for example.

Information on constraints may include information on revised or new shipping requirements, for example.

Hence, the method is capable to adapt to new scenarios in the environment of the transportation network, which influence the transportation rates. Additionally, live event updates are taken into consideration, if required for answering the question obtained from the operator.

The computer-implemented method for analyzing a transportation network according to an embodiment includes, in the generated response, visual information on the transportation network generated based on the adjusted network graph. The visual information includes at least one of a heat map of traffic, timelines of expected delivery changes, and graphical representations of resource reallocations.

The computer-implemented method for analyzing a transportation network according to one embodiment comprises acquiring the current unstructured information relevant to the critical transportation routes from the plural information sources in real-time.

A non-transitory computer-readable storage medium embodying a program of machine-readable instructions executable by a digital processing apparatus cause the digital processing apparatus to perform operations according to one of the embodiments of the first aspect.

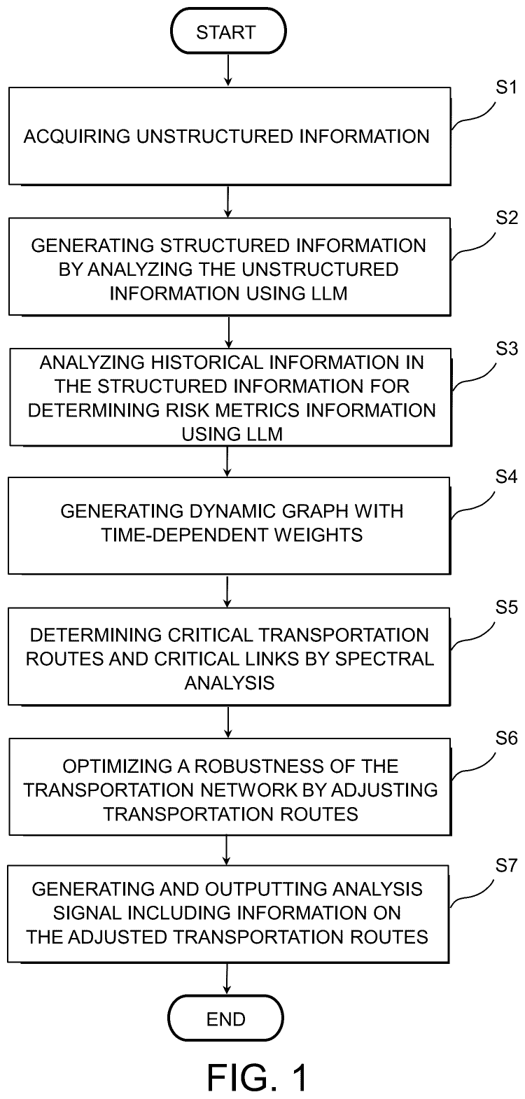

FIG. 1 shows a flowchart providing an overview over a method for analyzing a transportation network in a logistic supply chain.

The method starts with a step S1 of acquiring unstructured information from plural information sources and information on the transportation network.

In step S2, the method analyzes the unstructured information utilizing a large language model for generating structured information.

In step S3, the method analyzes historical information in the structured information and identifies correlations between events and disruptions in the transportation network for determining risk metrics.

In step S4, the method proceeds with generating a dynamic graph comprising nodes and edges, wherein time-dependent weights associated with the edges represent transportation rates along the edges.

The method determines critical transportation routes and critical links of the transportation network in step S5 by performing a spectral analysis of the dynamic graph utilizing the determined risk metrics.

In step S6, the method minimizes a risk of the transportation network by adjusting transportation routes based on the critical transportation routes and the critical links and based on the risk metrics until a termination criterion is met.

The method proceeds in step S7 with generating and outputting an analysis signal including information on the adjusted transportation routes of the transportation network when the termination criterion has been met.

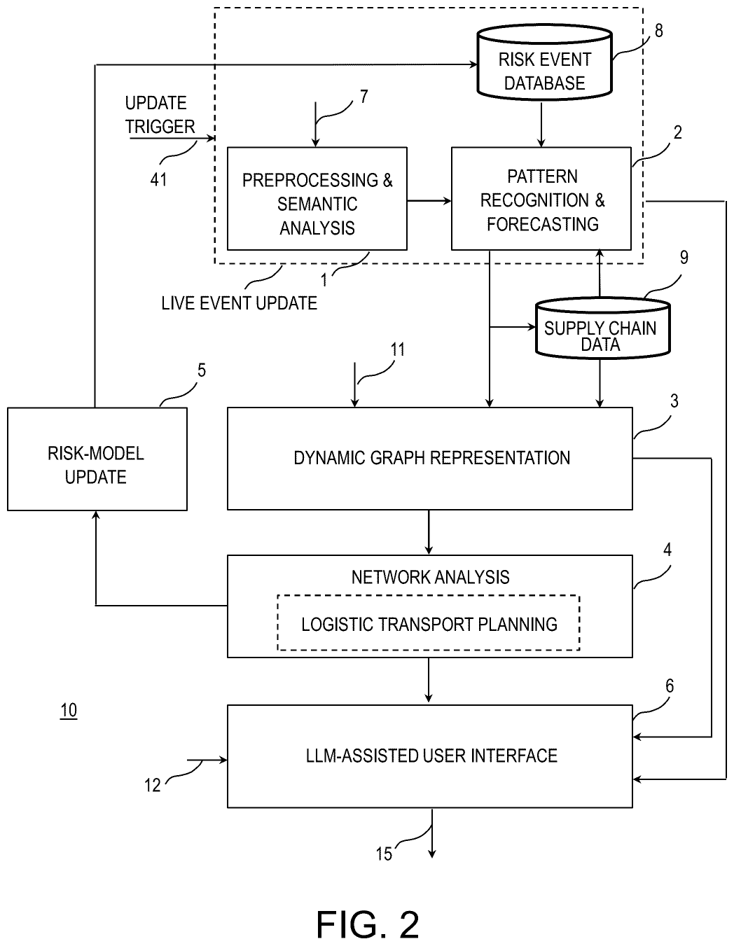

FIG. 2 shows a block diagram illustrating an overview over a system 10 for analyzing a transportation network in a logistic supply chain.

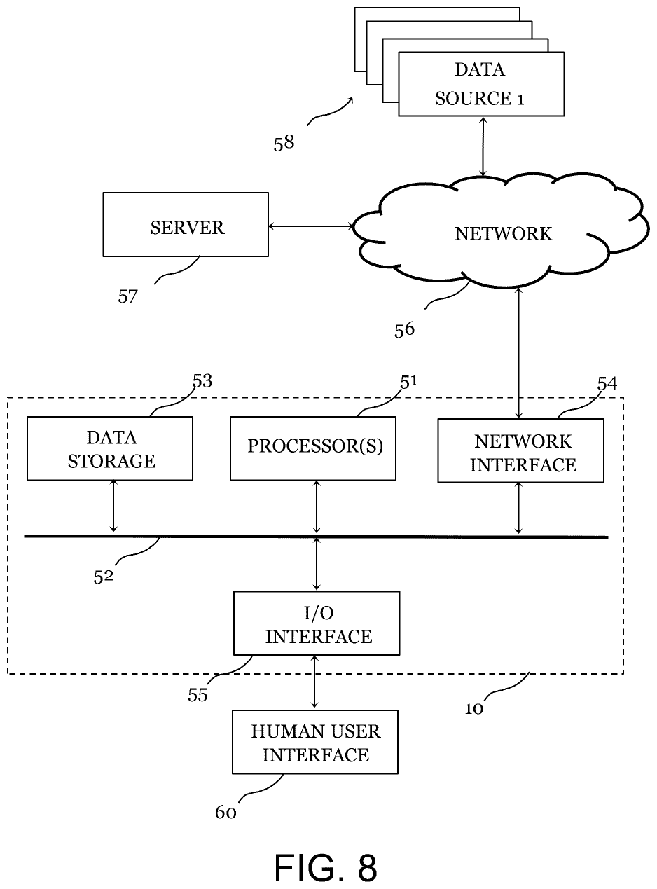

The system 10 of the discussed embodiment is in particular a computer-implemented system 10, which includes a plurality of modules implemented in software, in particular in a plurality of software modules running on hardware. Considerations on the processing hardware for the implementation are discussed with reference to FIG. 8.

The system 10 for analyzing a transportation network in a logistic supply chain includes a preprocessing-and-semantic-analysis module 1, a pattern-recognition-and-forecasting module 2, a dynamic-graph-representation module 3, a network-analysis-module 4, a risk-model-update module 5, and an LLM-assisted user interface 6.

The block diagram of FIG. 2 depicts the system 10 for analyzing a transportation network that includes the LLM-assisted user interface 6. Alternatively, the system 10 may include an input-output interface 55, as illustrated in the embodiment shown in FIG. 8. The input/output interface 55 outputs the analysis signal including information on the adjusted transportation routes of the transportation network.

In particular, the input-output interface 55 outputs the analysis signal to a navigation system including information on at least one adjusted transportation route of the transportation network for direct implementation of the at least one adjusted transportation route in the navigation system of an autonomous, semi-autonomous or human-controlled transportation means, e.g., a road transport vehicle.

The system 10 for analyzing a transportation network in a logistic supply chain further includes a risk-event database 8 and a supply-chain database 9. The risk-event database 8 and the supply-chain database 9 shown in FIG. 2 are implemented based on a memory 53 of the system 10. Alternatively, the risk-event database 8 and the supply-chain database 9 may be implemented based on at least one server 57, and the system 10 includes a network interface 54 for accessing information stored in the risk-event database 8 and the supply-chain database 9 via a network 56.

The preprocessing-and-semantic-analysis module 1 acquires unstructured information 7 from plural information sources 58 and information on the transportation network. The unstructured information 7 includes current information, and in particular real-time information, which is information that is valid for a current period of time. The unstructured information 7 further includes historic information, which includes information, which is valid for periods of time before the current time (period of time).

The plural information sources 58 include, e.g., social media and news channels.

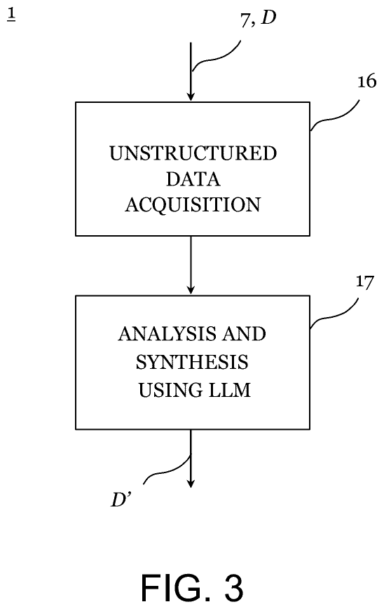

The preprocessing-and-semantic analysis module 1 analyzes the unstructured information utilizing a large language model for generating structured information from the acquired unstructured information. The preprocessing-and semantic-analysis module 1 is discussed in more detail in FIG. 3.

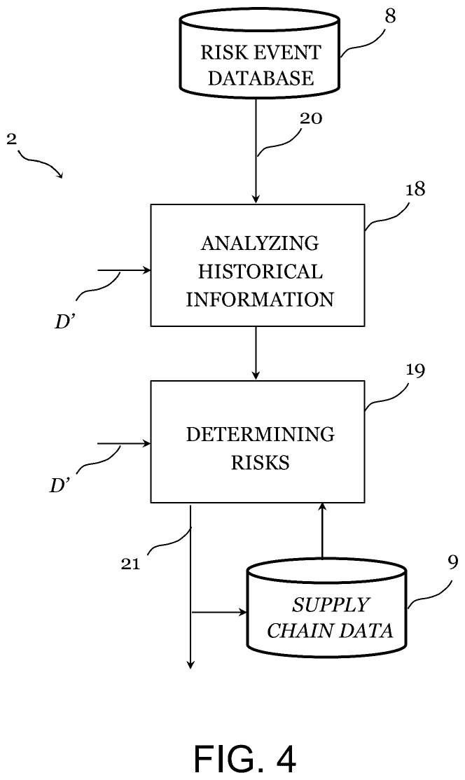

The pattern-recognition-and-forecasting module 2 analyzes historical information in the structured information provided by the preprocessing-and-semantic analysis module 1 and identifies correlations between events and disruptions in the transportation network for determining risk metrics R. The pattern-recognition-and-forecasting module 2 is discussed in more detail with respect to FIG. 4.

Processing in the preprocessing-and-semantic analysis module 1, the pattern-recognition-and-forecasting module 2, and the data storage capability of the risk-event database 8 in combination provides the capability to automatically collect unstructured information and to update the information on risks in the transportation network automatically based on the unstructured information and in a format forming a base for further processing in the system 10.

The supply-chain database 9 stores information on the logistic supply chain (supply chain), in particular information on a transportation network used in the supply chain.

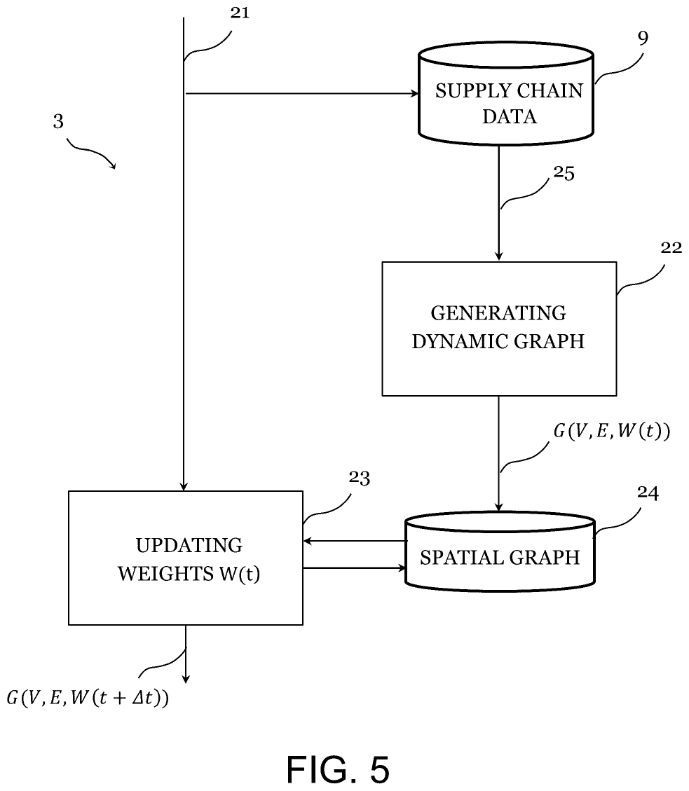

The dynamic-graph-representation module 3 generates the dynamic graph comprising nodes and edges. Time-dependent weights associated with the edges of the dynamic graph represent transportation rates of the transportation network along the edges of the dynamic graph. The dynamic-graph-representation module 3 is discussed in more detail with reference to FIG. 5.

The network-analysis-module 4 analyzes the dynamic graph using methods of spectral analysis. In particular, the network-analysis-module 4 determines critical transportation routes and critical links of the transportation network by performing a spectral analysis of the dynamic graph utilizing the determined risk metrics R.

The network-analysis-module 4 minimizes an overall risk of the transportation network by adjusting transportation routes based on the determined critical transportation routes and the critical links and based on the risk metrics until a termination criterion is met.

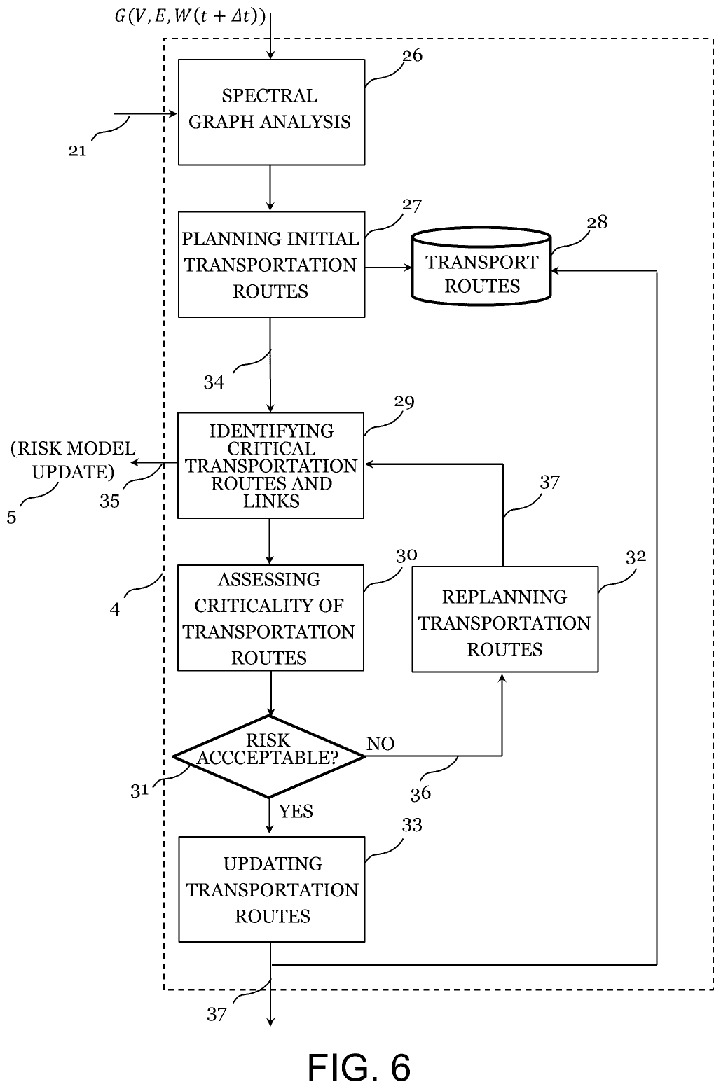

The network-analysis-module 4 is discussed in more detail with reference to FIG. 6.

The risk-model-update module 5 uses continuous updates from the critical supply chain paths to update the risk models according to expression (1)

$${P}_{new} = Θ ( {P}_{old} , Δ D ) , \qquad ( 1 )$$

thereby creating a capability of dynamically optimizing the transportation network in the system 10. In expression (1) P_{old} denotes the currently stored risk models in the risk event database 8, P_{new} are the updated risk models that are stored by the risk-model-update module 5 in the risk-vent database 8, respectively, and ΔD is the update in structured information (data).

The risk models stored in the risk-event database 8 include in particular predictive risk models for forecasting risks R.

The approach described in expression (10) allows executing an optimization of the transportation network iteratively, according to

$$S ( t + Δ t ) = Θ ( S ( t ) , {D}^{′} ( t + Δ t ) , Δ t ) ; \qquad ( 2 )$$

In expression (2), the term S(t+Δt) denotes the transportation network at the time (t+Δt), S(t) the transportation network at the time t, D′(t+Δt) the structured information D′ at the time (t+Δt), and Δt a duration of the time period for the step from t to (t+1) in an incremental time series formulation.

The LLM-assisted user interface 6 obtains a user input 12 including questions on aspects of the transportation network. The LLM-assisted user interface 6 analyzes an adjusted network graph including the adjusted transportation links utilizing the LLM for generating a response 15 to the obtained user input 12 based on the acquired user input 12 and the adjusted network graph stored in a network graph database. The LLM-assisted user interface 6 outputs the generated response 15 to the user.

The user input 12 includes questions on aspects of the transportation network, e.g., questions for information on risk levels associated with transportation routes, questions for alternative transportation routes, or questions for potential bottlenecks in the transportation network.

The LLM-assisted user interface 6 may obtain the user input 12 in an audible format, e.g. via microphone, alternatively the user input may be input in a written format. The LLM-assisted user interface 6 may convert the obtained user input 12 from an audible format into a natural language file.

The LLM-assisted user interface 6 may process the user input 12 utilizing natural language processing (NLP).

Alternatively or additionally, the user input 12 includes information on real-time events or information on constraints for the transportation network. The LLM-assisted user interface 6 analyzes the user input 12 for generating structured user input information forming part of the structured information utilizing the large language model.

Information on real-time events may include information of road closures, for example. The information on constraints may include information on revised shipping requirements or new shipping requirements, for example.

Hence, the system 10 can adapt to new or changed scenarios in the environment of the transportation network, which influence the transportation rates along the transportation links and the transportation routes.

Alternatively or additionally, the system 10 may take event updates obtained in real-time into consideration. This is particular advantageous when the system 1, in particular the LLM-assisted user interface 6, is generating a response 15 to the question obtained in the input signal 12 from the operator.

The LLM-assisted user interface 6 may generate and include in the generated response 15 to the user input 12, visual information on the transportation network generated based on the adjusted network graph. The visual information may include at least one of a heat map of traffic, timelines of expected delivery changes in the transportation network, and graphical representations of resource reallocations to the transportation links and transportation routes of the transportation network.

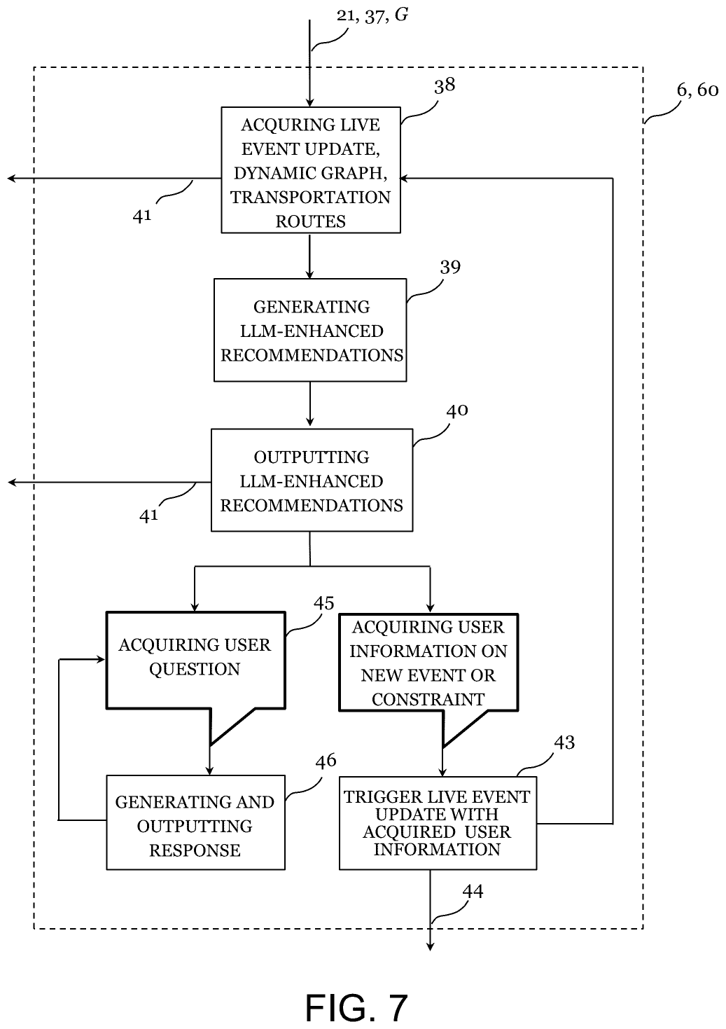

Further details of the LLM-assisted user interface 6 are discussed with reference to FIG. 7.

The risk-event database 8 stores information on risks, risk events, and updated risks. In particular, the risk-event-database 8 stores risk models and updated risk models that correspond to risks for potential disruptions in the transportation network.

The supply chain database 9 stores information on the logistic supply chain, in particular information on the transportation network.

FIG. 3 shows a block diagram illustrating preprocessing and semantic analysis by the preprocessing-and-semantic-analysis module 1 in the system 10 for analyzing a transportation network in a logistic supply chain.

The preprocessing-and-semantic-analysis module 1 comprises two functional blocks (submodules), an unstructured data acquisition module 16 and an analysis-and synthesis module 17.

The unstructured data acquisition module 16 acquires unstructured information from a plurality of information sources 58 and provides the acquired unstructured information to the analysis-and synthesis module 17.

The unstructured data acquisition module 16 acquires the unstructured information 7 as real-time data from the plural information sources 58 via a communication network 56, e.g. the world-wide-web (internet).

The unstructured information 7 (unstructured data 7) encompasses information, which either is not in a pre-defined data model or not organized in a pre-defined manner. Unstructured information 7 comprises characteristically text, but also includes data, e.g., dates, times, numerals and other facts. Unstructured information 7 often comprises irregularities and ambiguities that result in difficulties to understand and to interpret the unstructured information 7 using known programs when compared with information stored in an organized form, e.g., in fields or arrays in predefined data formats in databases or annotated, e.g., semantically tagged in text documents.

The plural information sources 58 include, e.g., social media, messenger services, news channels, traffic information channels, weather forecast channels, event databases, public information services run by public or private institutions, e.g. by communal services or state institutions. The plural information sources 58 comprise publicly available sources, which anyone may access without having to sign into an account.

The analysis-and synthesis module 17 analyzes the unstructured information 7 utilizing at least one large language model (LLM) for generating the structured information from the unstructured information.

The analysis-and synthesis module 17 employs the LLMs for a semantic analysis of the acquired unstructured information D, and to generate (synthesize) the structured information D′ based thereon. The structured information D′ is suitable for subsequent processing by the modules of the system 10:

$$S ( D ) \to {D}^{′} ; \qquad ( 3 )$$

By prompting LLMs, the analysis-and synthesis module 17 is able to extract relevant insights and translate the acquired unstructured information into a structured format D′ for the computer-based processing in the subsequent stages of the system 10, in particular the pattern-recognition-and-forecasting module 2.

The analysis-and-synthesis module 17 synthesizes the structured information, which complies with a predefined data model that organizes the individual elements of the information, standardizes how the individual elements of information relate to each other. Utilizing the LLMs in this process enables to automate at least partially a process that typically involved data experts or data specialists.

FIG. 4 shows a block diagram illustrating pattern recognition and forecasting by the pattern-recognition-and-forecasting module 2 in the system 10 for analyzing a transportation network in a logistic supply chain.

The pattern-recognition-and-forecasting module 2 comprises two functional blocks (submodules), a historical-information-analysis module 18 and a risk-determination module 19. The pattern-recognition-and-forecasting module 2 analyzes historical information in the structured information and identifies correlations between events and disruptions in the transportation network for determining risks metrics R.

The historical-information-analysis module 18 utilizes LLMs to analyze the historical information included in the structured information and information obtained from the risk event database 8. The historical-information-analysis module 18 identifies correlations

$$ρ ( {D}_{hist} , {D}_{curr} ) ; \qquad ( 4 )$$

between information on past events Dₕᵢₛₜ obtained from the risk event database 8 and current information D_{curr} that is included in the structured information D′ obtained from the analysis-and synthesis module 17.

The risk-determination module 19 of the system 10 detects motifs M(t) in the structured information D′ by representing structured information D′ as a sequence of events in a graph format using the identified correlations historical-information-analysis module 18 and applying advanced pattern recognition algorithm(s) on the generated graph representation. By applying at least one advanced pattern recognition algorithm, the risk-determination module 19 identifies recurring patterns in the form of subgraphs, generally known as motifs M(t) in the graph representation. The motifs M(t) signify critical interactions or flows between nodes in the graph representation.

Examples for advanced pattern recognition algorithms suitable for implementing the risk-determination module 19 include frequent subgraph mining. Techniques such as graph-based substructure pattern mining (gSpan) enable to identify common subgraphs that occur frequently in the graph representation of the dataset including the unstructured information D′. Based on the determined motifs M(t), the risk-determination module 19 estimates the impact of potential disruptions as risks in the transportation network and the likelihood risk metrics R associated with the identified risks.

Determining the risk metrics R in the risk-determination module 19 includes estimating a first risk metric and a second risk metric associated with each risk, wherein the first risk metric Rᵢₘₚ(M) represents an expected disruption impact of the risk and the second risk metric R_{occ}(M) a probability of occurrence of the risk associated with a motif M(t).

The risk-determination module 19 stores the identified risks associated with the risk metrics R in the supply chain database 9 as risk information 21, which also stores the information on the transportation network. The other modules of the system 10, e.g. dynamic-graph-representation module 3, access the supply chain database 9 for obtaining the information on the transportation network, as well as the risk information provided by the pattern-recognition-and-forecasting module 2, in particular by the risk-determination module 19.

FIG. 5 shows a block diagram illustrating generating and analyzing a dynamic graph representation in the dynamic-graph-representation module 3 of the system 10 for analyzing a transportation network in a logistic supply chain.

The dynamic-graph-representation module 3 comprises the functional blocks (submodules) dynamic-graph generating module 22, weight updating module 23 and a spatial-graph database 24.

The dynamic-graph generating module 22 represents (models) the transportation network based on the logistic supply chain data, and in particular the information on the transportation network 25 from the supply chain database 9 as a graph

$$G ( V , E , W ( t ) ) ; \qquad ( 5 )$$

In the dynamic graph G, the term V represents nodes of the dynamic graph G, the term E represents edges of the dynamic graph G, and the term W(t) denotes time-dependent, dynamically updated, weights of the edges over time.

The nodes V of the dynamic graph G represent, e.g., warehouses or distribution centers of the transportation network.

The edges E of the dynamic graph G represent, e.g., transportation links between the nodes V of the dynamic graph G.

The time-dependent weights W(t) associated with the edges E of the dynamic graph G represent transportation flows along the edges E of the dynamic graph G, in particular time-dependent transportation flow rates along the edges E of the dynamic graph G.

The dynamic-graph generating module 22 stores the generated dynamic graph G, in the spatial-graph database 24.

The weight updating module 23 updates the time-dependent weights

$$W ( t + Δ t ) = f ( W ( t ) , R , Δ t ) \qquad ( 6 )$$

based on real-time, current structured information D′ and current values of the risk metrics R determined in the risk assessment performed in the risk-determination module 19, and in particular on the risk information 21, thereby incorporating variations in the unstructured information D′ that affect departure and arrival times of transportation along the transportation links represented by the edges E of the dynamic graph G.

The term Δt defines a duration of the time period for the step from t to (t+1) in an incremental time series formulation in expression (6).

The dynamic-graph-representation module 3 provides the generated dynamic graph G and the capability to update the time-dependent weights W(t) of dynamic graph G based on updated risk information for further processing in the network analysis module 4. The data structure of the dynamic graph G ensures a computationally efficient evaluation of the current state of transportation network, which is enriched by the additional information generated using the LLM-based preprocessing in the pattern-recognition-and-forecasting module 2, in the subsequent network-analysis-module 4.

FIG. 6 shows a block diagram illustrating the analysis of the dynamic graph G representing the transportation network by the network-analysis-module 4 of the system 10 for analyzing a transportation network in a logistic supply chain.

The network-analysis-module 4 comprises the functional blocks (submodules) spectral-graph analysis module 26, initial-transportation-route planning module 27, transportation route database 28, critical-transportation-route identification module 29, criticality-assessing module 30, risk-evaluation module 31, transportation-route-replanning module 32, and a transportation route updating module 33.

The spectral-graph analysis module 26 obtains the dynamic graph G(V, E, W(t)) generated by the dynamic-graph-representation module 3 and stored in the spatial graph database 24, and performs spectral analysis of the dynamic graph G (transportation network graph), considering the time-dependent weights W(t) and current risk metrics R.

The spectral-graph analysis module 26 obtains the current risk metrics R, which are updated based on the current structured information D′, in the risk information from the supply chain database 9.

In a first iteration of the process (initial iteration), information from the supply chain database 9, executing the process of generating dynamic graph by the dynamic-graph-generating module 22 and the dynamic graph from the spatial-graph database 24 are required. The information is now all included in the stored dynamic graph in the spatial-graph database 24.

The information of the risk metrics R are stored as parts of the time-dependent weights W(t) of the dynamic graph G. The supply chain database 9 stores the information about any transportation requests by users, which includes, e.g., with time requirements such as requested departure times and arrival times, and the quantities of objects (goods, materials) for transportation. The information about transportation requests also includes a location (current location) of the objects scheduled for transportation, and a modal accessibility. The dynamic-graph-generating module 22 includes this information on the transportation network in the initial iteration to the information stored in the dynamic graph G in the spatial graph database 24. The modal accessibility refers to possible, e.g. allowed, transportation modes along the edges. The modal accessibility is determined by edge-specific modal restrictions, e.g., including weight limits for vehicles, height limits for vehicles, excluded transportation by lorries along the edges, for example.

For later iterations, the dynamic graph, in particular the time-dependent weights W(t), is only updated directly by the weight-updating module 23, based on the current structured information D′.

The initial-transportation-route planning module 27 then plans initial transportation routes 34, and stores the planned initial transportation routes in the transportation route database 28. In particular, the initial-transportation-route planning module 27 plans the initial transport routes by minimizing the risk along the transport routes based on the weights W(t) of the dynamic graph G for determining the initial transportation routes 34 in order to store them as a first iteration of the transportation routes.

The transportation route database 28 stores the initial transportation routes 34, replanned transportation routes 37 during the processing of the network analysis module 4, and updated transportation routes that are generated by the network analysis module 4.

The critical-transportation-route identification module 29 determines critical transportation routes and critical links of the transportation network by performing a spectral analysis of the dynamic graph W(t) utilizing the determined risk metrics R. The critical-transportation-route identification module 29 identifies main transportation routes and critical transportation links corresponding to edges in the dynamic graph W(t) based on a risk minimization of the initial transportation route 34, or an updated transportation route 37 after a first or further iteration of the processing in the network analysis module 4.

In particular, the criticality-assessing module 30 assesses a criticality of logistic transport routes and an overall network robustness by identifying areas that are vulnerable to disruptions in the transportation network base on the dynamic graph W(t). The identified areas in the physical world correspond to regions or subgraphs of the dynamic graph W(t).

The risk-evaluation module 31 evaluates a determined risk of the transportation routes and compares the determined risk with a risk threshold. In case of the determined risk exceeding the risk threshold (“NO”), the transportation-route-replanning module 32 starts a re-planning of the transportation routes and the critical-transportation-route identification module 29 again determines critical transportation routes and critical links of the transportation network, based on the replanned transportation routes 37 in a next iteration of the processing. In particular, the transportation-route-replanning module 32 dynamically adjusts the time-dependent transportation link weights W(t) and transportation routes based on edges E and adjusted weights Wadj of the risk models (predictive risk models).

$$W ( t ) = α ( E , {W}_{adj} ) , \qquad ( 7 )$$

The risk models stored in the risk event database are updated based on the determined critical transportation links and critical transportation routes. In particular, the adjusted weights Wadj of the risk models are updated based on the current time-dependent transportation link weights W(t), which base on the current structured information D′, hence real-time information.

In case of the determined risk exceeding the risk threshold (“YES”), the transportation route updating module 33 updates the transportation routes stored in the transportation route database 28 with the updated transportation routes 37. The network analysis module 4 iterates the replanning of logistic transport chain until risk is below the predetermined risk threshold and therefore considered acceptable.

The processing in the network analysis module 4 provides optimized updated transportation routes 37, which form the basis for generating the analysis signal.

The analysis signal may form the basis for route recommendations in a navigation system that controls movement of transportation means, e.g., a lorry, in the transportation network autonomously or under control of a driver.

FIG. 7 shows a block diagram illustrating the processing of the LLM-assisted user interface 6 in the system 10 for analyzing a transportation network in a logistic supply chain.

The LLM-assisted user interface 6 corresponding to the LLM-assisted user interface 60 of FIG. 8 comprises functional blocks (submodules) acquisition module 38, recommendation-generating module 39, recommendation-output module 40, user-question-acquisition module 45, response-generating module 46, user-information acquisition module 42, and live-event-trigger module 43.

The acquisition module 38 acquires real-time, unstructured information D relevant for the logistic supply chain, in particular unstructured information relevant for the transportation network. In particular, the acquisition module 38 controls the real-time acquisition of the unstructured information D from plural information sources 58 that provide data from information sources 58 relevant to the critical transportation route. The processing in the system 10 as discussed with reference to FIGS. 1 to 6 is therefore enabled to update the dynamic graph W(t) and the risk information 21 with respect to the critical transportation routes and the critical transportation links.

The acquired unstructured information D may include live event information such as traffic conditions, weather changes, or sudden logistical disruptions obtained by the acquisition module 38 by monitoring the information sources 58 and incorporating the unstructured information D provided by them.

The dynamic graph of the transportation network is updated in real-time, triggered by the LLM-assisted user interface 6, and thereby ensures that information affecting the transportation routes includes current structured information, updated risk metrics R, and adjusted transportation routes 37. The live event update triggered by the LLM-assisted user interface 6 with the update trigger signal 41 ensures enabling more accurate and dynamic modeling enhancing the quality of the recommendations to a user and responses to user questions.

The recommendation-generating module 39 generates optimized network adaptation recommendations REC based on an adjusted dynamic graph G according to expression (7)

$$REC = Λ ( LLM , {G}_{adj} ) ; \qquad ( 8 )$$

supported by an LLM-based analysis, highlighting reconfigured supply chain outputs and critical transportation routes based on updated unstructured information acquired in real-time. The recommendation-generating module 39 applies an LLM-based analysis to the adjusted dynamic graph G_{adj}.

The recommendation-generating module 39 uses an output from the LLM-based analysis, for controlling the system 10 in order to formulate strategies for adapting the transportation network for generating recommendations. The generated recommendations may focus on optimizing transportation routes, adjusting transportation schedules, and reallocating transportation resources in order to mitigate risks and capitalize on emergent opportunities in the logistic supply chain.

The recommendation output module 40 outputs the generated, LLM-enhanced recommendations in a recommendation signal to the user of the system 10 and the LLM-assisted user interface 6. The LLM-assisted user interface 6 therefore provides users with actionable insights and recommendations REC for implementing network adjustments ensuring optimal adaptation to dynamically changing real-time conditions and forecasts.

The user may pose questions to the LLM-assisted user interface 6.

The user-question-acquisition module 45 acquires questions from the user to the LLM-assisted user interface 6. The questions may regard specific aspects of the transportation network, including at least one of, e.g., questions on risk levels of transportation routes and the overall transportation network in a specific configuration, on alternative transportation routes, or on potential bottlenecks in the transportation network.

The response-generating module 46 generates and outputs responses to the acquired user questions, e.g., using natural language processing techniques to understand and generate the response to the user question, thereby providing tailored recommendations on the transportation network. For generating the responses, the response-generating module 46 relies on the updated information due to the live event update triggered by the LLM-assisted user interface 6 with the update trigger signal 41.

The user may input information on real-time events or on constraints manually to the system 10 using the LLM-assisted user interface 6.

The user-information acquisition module 42 acquires a user input that includes information on real-time events or information on constraints for the transportation network.

The live-event-trigger module 43 analyzes the user utilizing the LLM for generating structured user input information for the structured information, which then forms the basis for the live event update triggered by the LLM-assisted user interface 6 with the update trigger signal 41.

For example, the user could enter information about a road closure or a new shipping requirement concerning the transportation network. Once the user-information acquisition module 42 acquired the user information, the system 10 processes the information, recalculates its recommendations, taking the constraints input by the user into consideration as further unstructured information D′. The recommendations generated may include rerouting suggestions for the transportation network based on adjusted transportation routes, adjustments in shipment schedules, or changes in a resource allocation for transportation resources that adapt to the new scenario defined by the acquired user information.

Additionally, live event updates of unstructured information D are taken into consideration, triggered by the LLM-assisted user interface 6 with the update trigger signal 41 that the system 10 uses for triggering its processing.

Additionally, the LLM-assisted user interface 6 outputs relevant information for the transportation network in a post-processed format, e.g. in form of visual information allowing the users to see and analyze the impact of new events or constraints on the dynamic graph W(t) of the transportation network.

The output information 44 may include heat maps of traffic, timelines of expected delivery changes, and graphical representations of resource reallocations of the transportation network.

FIG. 8 provides a processing hardware example of the system 10 for analyzing a transportation network in a logistic supply chain.

The overview of FIG. 8 shows on a high level of abstraction an architecture of computer hardware elements suitable for running an embodiment of the computer-implemented method, and illustrates in particular interfaces to further hardware elements useful for understanding elements of the disclosure.

The system 50 of FIG. 8 includes a processor 51, a data storage 53 (memory 53), an input/output interface 55, and a network interface 54, which are all linked by a data bus 52.

The input/output interface 55 may in particular provide a capability to output information via visual or audible signals to a human user. The input/output interface 55 also provides the capability to obtain information and commands from the human user.

The input/output interface 55 may provide the capability to provide information to other devices, e.g. one or more navigation systems of transport systems transporting materials and physical objects along the transportation network of the logistic supply chain.

The input/output interface 55 represents an interface for connecting input/output devices 56 including, but not limited to keyboards, mouse, pointing devices, displays, microphones, loudspeakers or a combination thereof.

The input/output interface 55 may at least in part be implemented in software modules running on the processor 51.

The input/output interface 55 provides the system 50 communicate with a human user interface 60 according to the disclosure. The human machine interface 60 represents an example of the LLM-assisted user interface 6.

The processor 51 may be any type of controller or processor, and may even be embodied as one or more processors 51 adapted to perform the functionality discussed herein. As the term processor is used herein, the processor 51 may include using a single integrated circuit (IC), or may use a plurality of integrated circuits or other components connected, arranged or grouped together, such as controllers, microprocessors, digital signal processors (DSP), parallel processors, multiple core processors, custom ICs, application specific integrated circuits (ASIC), field programmable gate arrays (FPGAs). The processor 51 may further include adaptive computing ICs and associated memory, e.g. RAM, DRAM and ROM, and other ICs and components. Hence, the term processor 51 should be understood to equivalently mean and include a single IC, or arrangement of custom ICs, ASICs, processors, microprocessors, controllers, FPGAs, adaptive computing ICs, or some other grouping of integrated circuits which perform the functions discussed for the computer-implemented method, with associated memory, such as microprocessor memory or additional RAM, DRAM, SDRAM, SRAM, MRAM, ROM, FLASH, EPROM or E2 PROM.

The processor 51 with its associated memory may be adapted or configured via programming, FPGA interconnection, or hard-wiring to perform the methodology of the computer-implemented method. For example, the method may be programmed and stored, in the processor 51 with its associated memory or memory 53, and other equivalent components, as a set of program instructions or other code for subsequent execution when the processor 51 is operative, e.g. powered on and functioning.

The processor 51 may in particular provide the hardware on which software implementing the modules and submodules of the system 10 discussed with reference to FIGS. 2, 3, 4, 5, 6, and 7 run.

The memory 53, which may include a data repository or database, may be embodied in any number of forms, including within any computer or other machine-readable data storage medium, memory device or other storage or communication device for storage or communication of information, including, but not limited to, a memory IC, or memory portion of an integrated circuit, e.g., a resident memory within a processor 51, whether volatile or non-volatile, whether removable or non-removable, including without limitation RAM, FLASH, DRAM, SDRAM, SRAM, MRAM, FeRAM, ROM, EPROM or E2 PROM, or any other form of memory device, such as a magnetic hard drive, an optical drive, a magnetic disk or tape drive, a hard disk drive, other machine-readable storage or memory media such as a floppy disk, a CDROM, a CD-RW, digital versatile disk (DVD) or other optical memory, or any other type of memory, storage medium, or data storage apparatus or circuit, known. In addition, such computer readable media includes any form of communication media, which embodies computer readable instructions, data structures, program modules or other data in a data signal or modulated signal, such as an electromagnetic or optical carrier wave or other transport mechanism, including any information delivery media, which may encode data or other information in a signal, wired or wirelessly, including electromagnetic, optical, acoustic, RF or infrared signals, and so on. The memory 53 may be adapted to store various look up tables, parameters, coefficients, other information and data, programs or instructions of the software of the present disclosure, and other types of tables such as database tables.

The memory 53 in particular may store the various databases discussed of the system 10 with reference to FIGS. 2, 4, 5, and 6.

The processor 51 is programmed, using software and data structures of the disclosed computer-implemented method, for example, to perform the methodology of the present disclosure. Consequentially, the system 50 and the computer-implemented method of the present invention may be embodied as software, which provides such programming or other instructions, such as a set of instructions and/or metadata embodied within a computer readable medium, discussed above. In addition, metadata may also be utilized to define the various data structures of a look up table or a database. Such software may be in the form of source or object code, byway of example and without limitation. Source code further may be compiled into some form of instructions or object code including assembly language instructions or configuration information. The software, source code or metadata of the present invention may be embodied as any type of code, such as C, C++, SystemC, LISA, XML, Java, Brew, SQL and its variations, e.g., SQL 99 or proprietary versions of SQL, DB2, Oracle, or any other type of programming language which performs the functionality discussed herein, including various hardware definition or hardware modeling languages (e.g., Verilog, VHDL, RTL) and resulting database files (e.g., GDSII). As a consequence, a “construct”, “program construct”, “software construct” or “software”, as used equivalently herein, means and refers to any programming language, of any kind, with any syntax or signatures, which provides or can be interpreted to provide the associated functionality or methodology specified when instantiated or loaded into a processor or computer and executed, including the processor 51, for example.

The software, metadata, or other source code of the present invention and any resulting bit file (object code, database, or look up table) may be embodied within any tangible storage medium, such as any of the computer or other machine-readable data storage media, as computer-readable instructions, data structures, program modules or other data, such as discussed above with respect to the memory 53, e.g., a floppy disk, a CDROM, a CD-RW, a DVD, a magnetic hard drive, an optical drive, or any other type of data storage apparatus or medium, as mentioned above.

The network interface 54 provides the system 50 with the capability to link to external databases, data sources 58 and servers 57 via a communication network 56. The network interface 54 in particular enables to implement the system 50 in a spatially distributed manner by performing at least some of the individual method steps at least in part remote from the system 50.

The data sources 58 provide the unstructured information D acquired by the pattern-recognition-and-forecasting module 2.

The system and method for analyzing a transportation network in a logistic supply chain present a technology for a tool that significantly enhances supply chain and logistics operations in different application scenarios. An advantageous application integrates the proposed tool for analyzing a transportation network into navigations systems for transport means used to implement the transportation links and transportation routes of the transportation network.

Companies may use the navigation system to reroute shipments dynamically in response to real-time traffic conditions, weather forecasts, and geopolitical events, thereby minimizing delays and reducing costs in the transportation network and the logistic supply chain of their operations. A car producer operating a global supply chain utilizes the tool to optimize its operations of warehouse facilities, resulting in reduced storage requirements due to increased reliability of the transportation network used for logistical transportation as a consequence, realizing respective savings in operating the warehouse facilities for physical objects and materials. This would contribute to improving the company's overall operational efficiency in production of physical objects and the efficiency for the logistic chain for replacement parts for the physical objects delivered to customers.

An implementation of the system 10 and the corresponding computer-implemented method establishes a comprehensive system integrating advanced data analysis capabilities and machine learning, particularly LLMs and spectral graph analysis, to optimize logistic supply chains and transportation networks dynamically and in real-time. The system 10 utilizes LLMs for processing the unstructured information D′, and transforming the unstructured information D into structured information D′, thereby providing a foundation for generating insights into the transportation network of the logistic supply chain.

The data models implemented by the system 10 are designed for a continuous adaptation during operation of the system 10, e.g., triggered by the update trigger signal 41 and thereby achieve a relevant and precise analysis as new unstructured information D emerges and is acquired.

Concurrently, the transportation network is conceptualized as a dynamic graph, whose nodes symbolize supply points and warehouses, and edges represent logistical transport links. Spectral graph analysis is applied to identify critical network paths and nodes, to maintain logistical flow and efficiency at advantageous computational cost for the system 10.

Insights gained from the LLM-based analysis are integrated with the dynamic graph, enabling a real-time recalibration of the time-dependent transportation link weights of the dynamic graph W(t). The recalibration of the time-dependent weights W(t) may be influenced by factors like risk assessments and traffic conditions, dynamically enhances the supply chain's operational efficiency.

The system 10 in combination with the LLM-based user interface 6, 60 provides users with an iterative feedback mechanism for refining decision-making by an evaluation of actions taken by the user. By extracting motifs M(t) from successful strategies in historical information and encoding them into an Eigenvector representation of the spectral graph analysis, the system 10 abstracts and generalizes patterns of effective adjustments.

The encoding of the information and data in the system 10 enables recognition and application of analogous optimization strategies under future scenarios, creating a dynamic repository of empirically validated responses. Thereby, the capability of the system 10 and the data modelling to generalize from past outcomes in historical information to future scenarios, enables progressively optimizing decision-making algorithms and increasing a precision of the supply chain's precision and an efficiency in countering disruptions in the logistic supply chain.

The framework implemented in the system 10 and the corresponding computer-implemented method coordinates and controls the process, offering a user interface for operators controlling logistic supply chains to access real-time recommendations and insights for optimizing logistical parameters. This includes a robust monitoring and feedback loop for continuous system improvement of the transportation network. Furthermore, it ensures the practical application of the predictive capabilities of the system 10 for anticipatory adjustments, significantly enhancing resilience and adaptability of the logistic supply chain.

The system 10 represents a significant advancement in controlling logistic supply chains, controlling transportation networks, and even supply chain management, offering a scalable and efficient solution for dynamic logistic environments. In application scenarios, implementations of the system 10 enable businesses to adapt to unexpected disruptions, such as environmental disasters or sudden regulatory changes, minimizing operational delays and maintaining efficient supply chain operations by the technical features of the system 10 and the corresponding computer-implemented method. Therefore, the system 10 and the corresponding computer-implemented method provide advantageous industrial applications.

All steps which are performed by the various entities described in the present disclosure as well as the functionalities described to be performed by the various entities are intended to mean that the respective entity is adapted to or configured to perform the respective steps and functionalities.

All features described above or features shown in the figures can be combined with each other in any advantageous manner within the scope of the disclosure. In the detailed discussion of embodiments, numerous specific details were presented for providing a thorough understanding of the invention defined in the claims. It is evident that putting the claimed invention into practice is possible without including all the specific details.

In the specification and the claims, the expression “at least one of A and B” may replace the expression “A and/or B” and vice versa due to being used with the same meaning. The expression “A and/or B” means “A, or B, or A and B”.

What is claimed is:

1. A computer-implemented method for analyzing a transportation network in a logistic supply chain, the method comprising:
acquiring unstructured information from plural information sources and information on the transportation network;
analyzing the unstructured information utilizing a large language model for generating structured information;
analyzing historical information in the structured information and identifying correlations between events and disruptions in the transportation network for determining risks metrics;
generating a dynamic graph comprising nodes and edges, wherein time-dependent weights associated with the edges represent transportation rates along the edges;
determining critical transportation routes and critical links of the transportation network by performing a spectral analysis of the dynamic graph utilizing the determined risk metrics;
minimizing a risk of the transportation network by adjusting transportation routes based on the critical transportation routes and the critical links and based on the risk metrics until a termination criterion is met;
generating and outputting an analysis signal including information on the adjusted transportation routes of the transportation network when the termination criterion has been met.

2. The computer-implemented method for analyzing a transportation network according to claim 1, wherein
determining the risk metrics includes estimating a first risk metric and a second risk metric associated with each risk, wherein the first risk metric represents an expected disruption impact of the risk and the second risk metric a probability of occurrence of the risk.

3. The computer-implemented method for analyzing a transportation network according to claim 1, wherein
determining the risk metrics includes
representing the structured information in a graph in a sequence of events,
detecting motifs in the graph that correspond to recurring subgraphs in the graph that are determined by applying an advanced pattern recognition algorithm on the graph,
estimating the risk metrics based on the detected motifs in the graph.

4. The computer-implemented method for analyzing a transportation network according to claim 1, wherein
generating the dynamic graph includes modelling the transportation network based on the information on the transportation network with edges between nodes representing transportation links with the time-dependent weights and storing the dynamic graph in a dynamic graph database.

5. The computer-implemented method for analyzing a transportation network according to claim 1, wherein
the acquired unstructured information includes current unstructured information, and
the method includes
updating the risk metrics based on current structured information generated by analyzing the unstructured current information using the LLM,
determining the critical transportation routes and the critical links of the transportation network by performing the spectral analysis of the dynamic graph utilizing the updated risk metrics;
minimizing the risk of the transportation network by adjusting the transportation routes based on the critical transportation routes and the critical links and based on the updated risk metrics until a termination criterion is met.

6. The computer-implemented method for analyzing a transportation network according to claim 1, wherein
acquiring the unstructured information from the plural information sources that include at least one of media platforms, news providers, podcast distributing platform, new agencies.

7. The computer-implemented method for analyzing a transportation network according to claim 1, wherein
the structured information comprises the historical information including risk information on past events from a risk event database.

8. The computer-implemented method for analyzing a transportation network according to claim 1, wherein the method comprises
acquiring logistic supply chain data including information the transportation network.

9. The computer-implemented method for analyzing a transportation network according to claim 1, wherein
the acquired unstructured information includes current unstructured information; and
the method comprises a step of
updating predictive risk models stored in the risk event database based on a difference of current unstructured information and previously acquired unstructured information relevant for the critical transportation routes.

10. The computer-implemented method for analyzing a transportation network according to claim 1, wherein the method comprises,
for each time step,
acquiring real-time information including current unstructured information;
analyzing the current unstructured information utilizing the large language model for generating current structured information;
updating the risk metrics for each risk stored in the risk event database based on the current structured information;
updating the time-dependent weights of the dynamic graph stored in the dynamic graph database based on the current structured information and the risk metrics stored in the risk event database for determining variations that affect departure and arrival times of transported items between nodes along the respective edge and storing the updated time-dependent weights for an updated dynamic graph in the dynamic graph database;
determining initial transportation routes of the transportation network by performing the spectral analysis of the updated dynamic graph utilizing the updated risk metrics and storing the initial transport routes as transport routes in a route database;
determining a main transport route and critical transportation links based on minimizing the updated risk metrics of the transportation routes stored in the route database;
minimizing the risk of the transportation network by adjusting the transportation routes based on the main transportation route and the critical transportation links and based on the updated risk metrics until the termination criterion is met;
generating and outputting the analysis signal including information on the adjusted transportation routes of the transportation network when the termination criterion has been met.

11. The computer-implemented method for analyzing a transportation network according to claim 10, wherein minimizing the risk of the transportation network comprises,
for each time step,
determining areas of the dynamic graph that are vulnerable to disruptions for assessing a criticality of the transportation routes and an overall network robustness of the transportation network, and
outputting the determined areas of the dynamic graph in the analysis signal.

12. The computer-implemented method for analyzing a transportation network according to claim 10, wherein minimizing the risk of the transportation network comprises,
for each time step,
adjusting iteratively the time-dependent weights and transportation routes based on updated risk models stored in the risk event database, determining an overall risk measure of the transportation network, until the overall risk measure is below a risk threshold, and
in case the determined overall risk measure is below the risk threshold, storing the adjusted transportation routes in the transportation route database.

13. The computer-implemented method for analyzing a transportation network according to claim 1, wherein the method comprises
analyzing an adjusted network graph including the adjusted transportation links utilizing the LLM for generating strategies for adapting the transportation network;
generating optimized network adaptation recommendations based on the generated strategies; and
outputting the optimized network adaptation recommendations via a user interface.

14. The computer-implemented method for analyzing a transportation network according to claim 1, wherein the method comprises
obtaining, via a user interface, a user input including questions on aspects of the transportation network;
analyzing an adjusted network graph including the adjusted transportation links utilizing the LLM for generating a response to the user input based on the acquired user input and the adjusted network graph stored in the network graph database;
outputting the generated response to the user via the user interface.

15. The computer-implemented method for analyzing a transportation network according to claim 14, wherein
the user input includes information on real-time events or information on constraints for the transportation network; and
the method comprises analyzing the user input for generating structured user input information in the structured information utilizing the large language model.

16. The computer-implemented method for analyzing a transportation network according to claim 14, wherein
the generated response comprises visual information on the transportation network generated based on the adjusted network graph,
wherein the visual information includes at least one of a heat map of traffic, timelines of expected delivery changes, and graphical representations of resource reallocations.

17. The computer-implemented method for analyzing a transportation network according to claim 11, wherein the method comprises,
acquiring the current unstructured information relevant to the critical transportation routes from the plural information sources in real-time.

18. A non-transitory computer-readable storage medium embodying a program of machine-readable instructions executable by a digital processing apparatus cause the digital processing apparatus to perform operations according to claim 1.

19. A system for analyzing a transportation network in a logistic supply chain, the system comprising:
a processor, a data storage, a network interface and an output interface; and
the processor is configured to acquire, via the network interface, unstructured information from plural information sources and information on the transportation network;
the processor is further configured to analyze the unstructured information utilizing a large language model for generating structured information,
to analyze historical information in the structured information and identifying correlations between events and disruptions in the transportation network for determining risks metrics,
to generate a dynamic graph comprising nodes and edges, wherein time-dependent weights associated with the edges represent transportation rates along the edges,
to determine critical transportation routes and critical links of the transportation network by performing a spectral analysis of the dynamic graph utilizing the determined risk metrics,
to minimize a risk of the transportation network by adjusting transportation routes based on the critical transportation routes and the critical links and based on the risk metrics until a termination criterion is met, and
to generate and output, via an output interface, an analysis signal including information on the adjusted transportation routes of the transportation network when the termination criterion has been met.
